(19) United States
(12) Patent Application Publication
(10) Pub. No.: US 2022/0042359 A1
(43) Pub. Date: Feb. 10, 2022

(54) LIFT SUPPORT BRACING DEVICE AND METHOD

(71) Applicant: Timothy B. Bothwell, Phoenix, AZ (US)

(72) Inventor: Timothy B. Bothwell, Phoenix, AZ (US)

(21) Appl. No.: 17/393,588

(22) Filed: Aug. 4, 2021

Related U.S. Application Data
(60) Provisional application No. 63/061,009, filed on Aug. 4, 2020.

(51) Int. Cl. E05C 17/54

(52) U.S. Cl. CPC E05C 17/54; E05Y 2900/532; E05Y 2900/546; E05Y 2201/218

(57) ABSTRACT

A bracing device, for use with a lift support body and a piston rod connected to the lift support body, comprises a piston rod fastener configured to be selectively attachable to an outer surface of the piston rod so as to extend between the lift support body and the coupling device when attached to the piston rod. The bracing device additionally includes a lift support body fastener coupled to the piston rod fastener and configured to be selectively attachable to an outer surface of the lift support body. The piston rod fastener is disconnected from the piston rod when the lift support body fastener is attached to the outer surface of the lift support body.

### CROSS-REFERENCE TO RELATED APPLICATIONS

This application claims the benefit of U.S. Provisional Application No. 63/061,009, filed Aug. 4, 2020, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to the field of lift supports such as gas springs, gas and mechanical struts, gas and mechanical shocks, and gas and mechanical dampers. More particularly, the present disclosure relates to devices and methods for bracing malfunctioning or failed lift support elements

### 2. Related Art

Lift supports are a group of related products typically used to assist in the lifting, opening, and/or closing of transitionable elements such as lids, covers, hatches, windows, conveyors, and seats. Typically, these lift supports operate by pairing an enclosed cylindrical body containing compressed gas or other type of mechanical spring alongside a hydraulic circuit and a sliding, telescoping piston in order to assist, resist, or dampen the linear motion of the sliding piston. Depending on their intended purpose, their particular parameters, and often the custom of any given industry or application in which they may be utilized, these lift supports are variously called, among other things, springs, struts, shocks, or dampers.

Lift supports serve a variety of purposes and may be used in countless applications involving a transitionable element. Prominently, many if not most modern consumer automobiles are equipped with lift supports at multiple different locations in order to enable consumers to more easily operate or actuate the transitionable elements on their automobiles. For example, the rear doors of hatchback-style vehicles are frequently provided with one or more lift supports in order to assist in opening or closing the rear door, or in maintaining the rear door in an open or partially opened position. Other automobile doors, especially more exotic styles such as scissor or gull-wing doors, may rely on lift supports to assist in their functioning. Similarly, the opening of other compartments such as the doors, lids, hatches, tailgates or covers of cargo areas such as engine bays, trunks, or flatbeds also frequently come equipped with lift supports. In these automotive applications, lift support elements may be used to permit the smooth actuation of doors or hatches, and to either maintain those doors or hatches in an open, partially opened, or closed position against the force of gravity, or to resist the tendency of those doors or hatches to rapidly open or close with great momentum, which may cause damage to the automobile or its components or the contents carried within, or even injury to its occupants or those nearby.

Inherent to many lift supports, especially those intended for general use in consumer products and which use enclosed cylinders of compressed gas as their mechanical spring element, is the possibility or even the inevitability of malfunction or failure. Most commonly, such failures of lift supports results from a partial or complete loss of pneumatic or hydraulic integrity in the pneumatic or hydraulic components, which generally results in the piston element suffering a partial or complete loss of its ability to resist motion. In the consumer automotive context where the lifting element is used to maintain a hatch or door open against the force of gravity, this will generally result in the hatch or door becoming unsupported by the lifting element, with the piston telescoping in to the body of the lifting element due to its inability to provide sufficient resistance.

Failure of a lift support on a hatch or door of an automobile is a commonplace occurrence, and may result in substantial inconvenience to the users of the automobile, who for a variety of reasons may need to utilize or access the portion of the vehicle containing the failed lift support. For example, it may be desired or necessary to actuate hatches or doors during the intervening time between failure and repair or replacement of the lift support, or during the repair or replacement process of the lift support, or during the performance of other more pressing repairs, or at any other time when repair or replacement of the lift support may not be desired or feasible. Without a properly functioning lift support, performance of these functions may become substantially more difficult.

Therefore, it may be seen there is a need in the art for novel ways to at least partially or temporarily restore certain functionalities of transitional elements such as hatches or doors in cases where a lift support has malfunction or failed.

### BRIEF SUMMARY

In accordance with one embodiment of the present disclosure, there is provided a bracing device for use with a lift support body and a piston rod connected to the lift support body. The piston rod includes a coupling device attached thereto and is transitional relative to the lift support body between an extended position and a retracted position, with the coupling device moving away from the lift support body as the piston rod transitions from the retracted position toward the extended position. The bracing device comprises a piston rod fastener configured to be selectively attachable to an outer surface of the piston rod so as to extend between the lift support body and the coupling device when attached to the piston rod. The bracing device additionally includes a lift support body fastener coupled to the piston rod fastener and configured to be selectively attachable to an outer surface of the lift support body. The piston rod fastener is disconnected from the piston rod when the lift support body fastener is attached to the outer surface of the lift support body.

The piston rod fastener may be integrally formed with the lift support body fastener.

The piston rod fastener may include a pair of jaws being flexible relative to each other between an expanded position and a compressed position, wherein the pair of jaws move away from each other as they transition from the compressed position toward the expanded position. Each of the pair of jaws may include a prescribed profile including an arcuate segment. Each of the pair of jaws may also include a pair of discrete arcuate segments.

The lift support body fastener may include a pair of jaws being flexible relative to each other between an expanded position and a compressed position, wherein the pair of jaws move away from each other as they transition from the compressed position toward the expanded position. Each of the pair of jaws may include a prescribed profile including an arcuate segment. Each of the pair of jaws may also include a pair of discrete arcuate segments.

The piston rod fastener may include a uniform cross section along a length of the piston rod fastener between opposed end faces thereof.

The lift support body fastener may include a uniform cross section along a length of the lift support body fastener between opposed end faces thereof.

The bracing device may additionally include a joint region disposed between the piston rod fastener and the lift support body fastener, the piston rod fastener extending from the joint region in a direction opposite the lift support body fastener.

According to another embodiment, the bracing device includes a first fastener having a pair of opposing first fastener bodies separated from each other and configured to be selectively attachable to the piston rod, with the piston rod being captured between the pair of opposing first fastener bodies, so as to extend between the lift support body and the coupling device when attached to the piston rod. A second fastener is coupled to the first fastener and includes a pair of second fastener bodies separated from each other and configured to be selectively attachable to the lift support body, with the lift support body being captured between the pair of opposing second fastener bodies, the first fastener being disconnected from the piston rod when the second fastener is attached to the outer surface of the lift support body.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a lift support including a lift support body and an extendable piston rod;

FIG. 2 is a front view of a bracing device constructed in accordance with one embodiment of the present disclosure; and

FIG. 3 is a side schematic view of the bracing device; and

FIG. 4 is a lower perspective view of the bracing device.

Common reference numbers are used throughout the drawings and the detailed description to indicate the same elements.

### DETAILED DESCRIPTION

According to various embodiments of the present disclosure, a bracing device is contemplated in which, following transition of the piston rod of a lift support to at least a partially extended positioned, the bracing device may be transitioned for placement at the piston rod according to a bracing configuration, which will result in the piston rod being retained in an at least partially extended position. Further, it is contemplated that the bracing device may also be configured so as to be transitionable into a storage configuration, whereby it may be placed and retained with the lift support in an unobtrusive fashion that does not interfere with the motion of the piston rod. Thus, it may be seen that the bracing device will be stored in a fashion that will ensure its ready availability for use following extension of the piston rod and will reduce any tendency towards misplacement or becoming unfastened or ajar, which may result in the bracing element becoming lost or poorly positioned, or in damage to the bracing element or other components during operation of the lift support or other components.

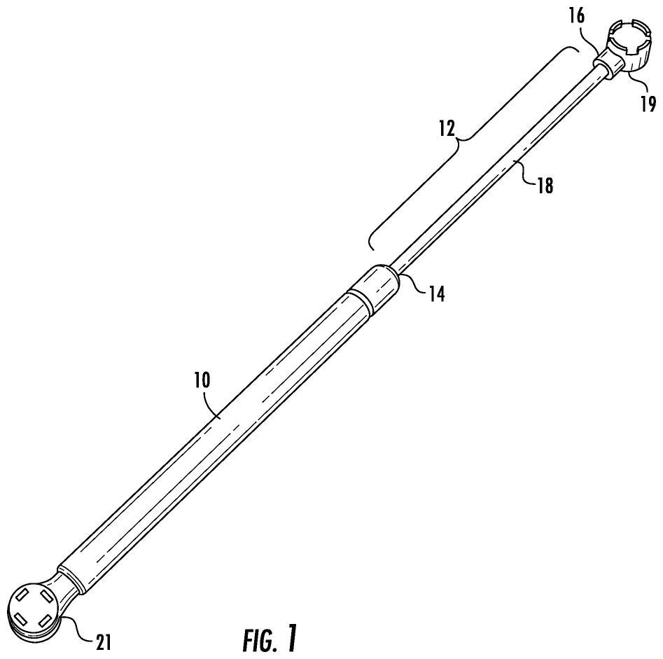

Turning now to FIG. 1, an illustration of a conventional lift support may be seen. It may be seen that a conventional lift support may include a lift support body 10 and a piston rod 18 which protrudes from one end 14 of the lift support body 10. In FIG. 1, the exemplary lift support is a conventional gas spring pneumatic cylinder wherein a piston (not shown) is disposed within and reciprocally movable within the hollow interior of the lift support body 10, with the piston rod 18 being attached to and extending axially from the piston so as to protrude from the end 14 of the support lift body 10 as indicated above. The lift support body 10 may be configured to contain the mechanical, pneumatic, and/or hydraulic components necessary to permit the operation of the lift support according to the particular purpose for which it has been designed, and is configured to receive at least a portion of the piston rod 18 in a telescoping fashion. In this regard, in the normal operation of the lift support, the exposed length of the piston rod 18 (exemplified by the reference number 12 in FIG. 1) is variable. The piston rod 18 includes a distal end 16 which always resides outside of the lift support body 10 and includes a coupling device 19 attached thereto. In a similar fashion, a coupling device 21 is attached to that end of the lift support body 10 opposite the end 14 thereof. As will be recognized, these coupling devices 19, 21 are typically used to operatively, pivotally couple the lift support between two other separate structures. As indicated above, the piston rod 18 may be seen to transition between one or more configurations during operation, comprising full or partially retracted or extended configurations, wherein portions of the piston rod 18 may be extended from or retracted into the lift support body 10 in a generally telescoping fashion.

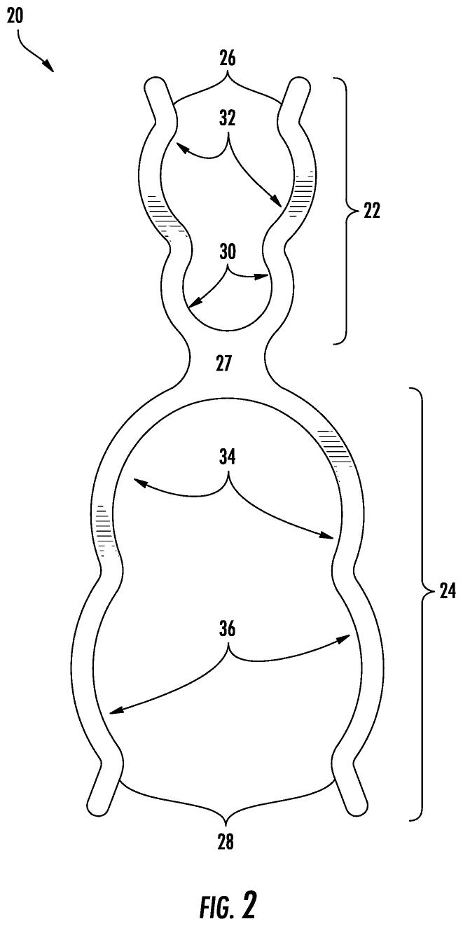

Turning now to FIG. 2, a front schematic view of a bracing device 20 is shown according to an exemplary embodiment of the present disclosure. It may be seen that the exemplary embodiment of a bracing device 20 may comprise a piston rod fastener 22 (e.g., a first fastener) and a lift support body fastener 24 (e.g., a second fastener), with the piston rod fastener 22 and the lift support body fastener 24 being joined together at a joint region 27. It is contemplated that the bracing device 20 may be an unitary unit, with the piston rod fastener 22 being integrally formed with the lift support body fastener 24 According to the exemplary embodiment, the piston rod fastener 22 and the lift support body fastener 24 may take the form of a clip, with each of the piston rod fastener 22 and the lift support body fastener 24 respectively being formed of an opposed pair of jaws (e.g., fastener bodies) 26, 28.

It may be seen that via forming at least the jaws 26, 28 from a flexible material configured to flex outward (e.g., an expanded position) and subsequently tension inward (e.g., a compressed position), the respective jaws 26, 28 of the piston rod fastener 22 and lift support body fastener 24 may be configured to grip against a suitable surface (e.g., an outer surface) against which they may be attached to. Many such suitable materials are known in the art, and may include metals or plastics, among other materials. In the exemplary embodiment, the entire bracing device is formed of a plastic polymer such as polyvinyl chloride (PVC), polyethylene, or polypropylene. However, it may be seen that in other embodiments, other materials may be utilized, such as steel or aluminum, and that certain portions of the bracing device 20 may be formed of certain materials, and other portions formed of other materials. It may also be seen that the jaws 26 of the piston rod fastener 22 may be configured to have one or more jaw profiles 30, 32 at regions of the jaws 26 sized and dimensioned in order to permit the jaws 26 to grasp and apply tension to a piston rod 18 of a size sufficient to enable to flexible material of the jaws 26 to flex around and grasp the piston rod 18 of that particular size. Each jaw profile 30, 32 may include an arcuate segment, with the jaw profile 30 defining an arcuate segment that is smaller than the jaw profile 30. Further, as may be seen in the exemplary embodiment, via use of multiple piston jaw profiles 30, 32 for a single set of jaws 26 of the piston fastener 22, ideally in descending order to profile size, a single set of jaws 26 may be configured to engage with a broad range of sizes of piston rods 18. Likewise, a similar scheme may be utilized for the jaws 28 of the lift support body fastener 24, so that a single set of jaws 28 of the lift support body fastener 24 may be configured to engage with a broad range of sizes of lift support bodies 10 via use of multiple lift support body jaw profiles 34, 36. Each jaw profile 34, 36 may include an arcuate segment, with the jaw profile 34 defining an arcuate segment that is smaller than the jaw profile 36. Further, while it may be seen that the jaw profiles 30, 32, 34, 36 of the exemplary embodiment are generally rounded or arcuate so as to facilitate engagement with generally cylindrical piston rods 18 having circular cross-sections, and generally cylindrical lift support bodies 10 also having circular cross-sections, in other embodiments the jaw profiles 30, 32, 34, 36 may be other shapes, such as square, hexagonal, jagged, or otherwise formed in order to particularly suit a particular lift support. Those of ordinary skill in the art will recognize that the jaws 26 (including the jaw profiles 30, 32) of the piston fastener 22 are used when the bracing device 20 is being used in an operative, supporting configuration, and that the jaws 28 (including the jaw profiles of the 34, 36) of the support body fastener 24 are used when the bracing device 20 is put into a stowed configuration.

Turning now to FIG. 3, a side schematic view of a bracing device 20 is shown according to an exemplary embodiment. As may be seen, it may be desirable to form the bracing device 20 as an extruded manifold construction with a fixed or uniform cross-sectional profile. It may be seen that forming the bracing device 20 in this fashion will not only aid in speed and reduced cost of production via enabling production methodologies such as molded extrusions, but this will also permit the bracing device 20 to have a high compressive strength in the extrusion direction, which is the direction that the bracing device 20 will most likely bear the greatest amount of force when the piston fastener 22 is engaged against the piston rod 18 and a compressive force is applied to a failed or malfunctioning piston rod 18 of a lift support that is not itself capable of supporting a load such as a vehicle hatch. When such a compressive force is applied to the bracing device 20 with the piston fastener 22 of the bracing device 20 engaged with the piston shaft 18, such as via an opened vehicle hatch being pulled closed by the force of gravity, it may be seen that the piston rod 18 will only be permitted to telescope into the lift support body 10 until such time as the coupling device 19 engages or abuts one of the opposed longitudinal ends of the bracing device 20 while the opposite end thereof is simultaneously engaged to or abutted against the end 14 of the support lift body 10. In this arrangement, the bracing device 20 is compressively captured between the coupling device 19 and the lift support body 10, at which point the piston rod 18 will be braced and no longer permitted to telescope further into the lift support body 10. As will recognized, when the bracing device 20 is being used in a supportive function, the exposed length 12 of the piston rod 18 will essentially mirror the longitudinal length of the bracing device 20 between the opposed ends or end faces thereof abutting respective ones of the coupling device 19 and lift support body 10. Owing to the strength in compression of the bracing device 20, which in the exemplary embodiment may be seen to substantially benefit from its construction as extruded manifold construction with a fixed cross-sectional profile, an ideal bracing device 20 will suffice to reinforce a failed or malfunctioning lift support so as to permit a typical hatch to remain open indefinitely until removed by the user. In this way, it may be seen that the bracing device 20 may be used to maintain a hatch in an open position even when a lift support has completely failed, which may be useful in any number of circumstances. It may also be seen that the bracing device 20 may be fabricated in any number of possible lengths in order to facilitate bracing of a piston rod 18 of any particular stroke length, or desired portion of a stroke length sufficient to maintain a load at a particular orientation. It may further be seen that multiple bracing devices 20 having similar cross sections may be stacked alongside each other on the same piston rod 18, which may permit variation in the height (i.e., the exposed length 12) at which a piston rod 18 may be desired to be braced using the bracing device 20. Thus, it may be seen that it may be beneficial to provide a set of multiple bracing devices 20 having different extruded lengths but a similar cross section, so that different ones of the set may be used alone or in combination with each other to achieve a wide variety of possible bracing lengths.

It may also be seen that when a user desires to close a hatch or transit any other load with a failed or malfunctioning lift support, the user may remove the piston fastener 22 from the piston rod 18 of the lift support, which will enable the piston rod 18 to fully telescope within the lift support body 10 of the lift support, permitting the hatch or other load to fully transit to the position it would be in with the piston rod 18 fully telescoped within the lift support body 10. Prior to or following this transition, it may thus be seen that the user may engage the lift support body fastener 24 to the lift support body 10, thus maintaining the bracing device 20 in close proximity to the lift support at all times when not in active use bracing the piston rod 18. When engaged around the lift support body 10 and configured in an orientation that may not interfere with the transiting of the load such as the hatch (which may be, for example, with the bracing device 20 generally planar to the predominant plane of the hatch or other load), it may be seen that the bracing device 20 may remain fixed in place unobtrusively until the user needs to again use the bracing device 20 to brace the piston rod 18 of the lift support. This may substantially aid in preventing the bracing device 20 from becoming lost or knocked ajar, which may cause a safety risk, especially when used in the engine compartment of a motor vehicle where a loose object may interfere with the operation of the vehicle. This may also be seen to especially aid in the use of the bracing device 20 when the user must focus much of their attention on lifting the hatch or other load with reduced or no assistance that would otherwise be expected if they had a fully functional lift support. For example, a user who must lift a heavy vehicle hatch with one arm will be unlikely to be able to focus their attention on searching for a bracing device 20, which if loose may have been required to be stowed in a location difficult to access or which may have moved to a different location than last stowed during the motion of a vehicle to which the hatch may belong. By enabling the securing of the bracing device 20 to the lift support body 12 via the lift support fastener 24, the user will always know where the bracing device 20 is located and in which orientation it is in, and after a short period of time may be able to rapidly and easily retrieve, use, and disengage and store the bracing device 20 in order to easily and rapidly brace and unbrace a given load, in a fashion that will permit the hatch or other load to fully close or otherwise transition.

In the exemplary embodiment, the piston fastener 22 and the lift support body fastener 24 are configured to be positioned opposite to one another about the center of the cross-section of the bracing device 20 in a generally 180 degree relationship to one another, which may permit ease of stowage when engaged with lift support body fastener 24 around the lift support body 10, owing to a generally thinner profile which may permit greater closure of most hatches or other loads without interference from the bracing device 20. However, it may be seen that the relationship of the piston fastener 22 to the lift support body fastener 24 may be of any type, and that they do not necessarily need to have a 180 degree relationship, but rather may have configured according to the needs of the manufacturer and the user.

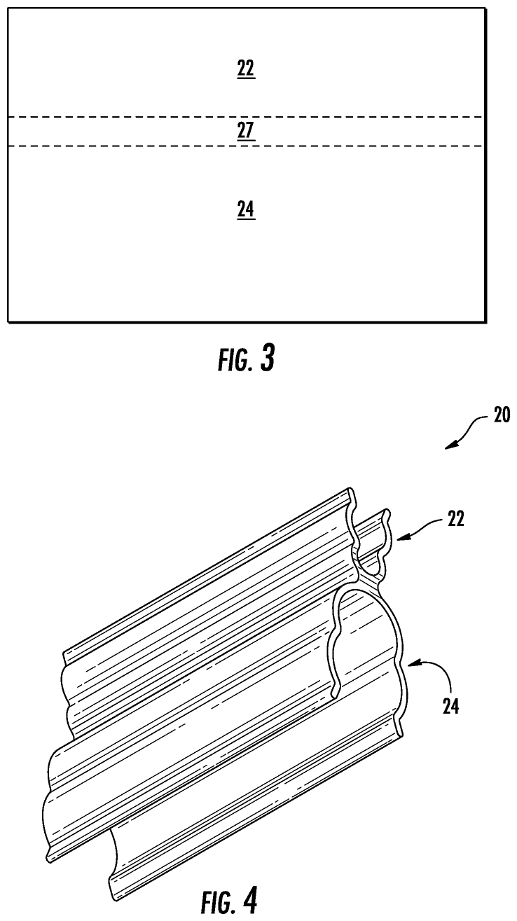

Turning now to FIG. 4, a perspective view of a bracing device 20 according to the exemplary embodiment is shown. It may be seen that another benefit of forming the bracing device 20 as a unitary structure with both a piston fastener 22 and a lift support body fastener 24 joined together, preferably with multiple sets of jaw profiles for each fastener, is that a cross-sectional structure having traits of a corrugated material may be realized, which may serve to greatly enhance the strength of the bracing device 20 along the direction of its fixed cross-sectional profile. Thus, it may be seen that even with the use of lightweight, thinner, flexible materials, a substantial load may be supported by the bracing device 20, owing to the substantial strength of the bracing device 20 along the direction it will receive transmitted force when the piston fastener 22 is engaged with the piston rod 18. It may further be seen that there may not necessarily be any strict difference between the piston fastener 22 or the lift support body fastener 24, and that these are merely terms of convenience, as in the case of a piston rod 18 of a diameter too large to accommodate a given piston fastener 22 of a bracing device, a lift support body fastener 24 of a given bracing device 20 may alternatively function to brace that piston rod 18 if it is of sufficient size to engage with the piston rod 18. In the case in which an especially large lift support is used such that the lift support body fastener 24 may be required to brace its piston rod 18 and in which the lift support body fastener 24 is of insufficient size to be stored around the lift support body 10 of the lift support, the bracing device 20 may simply be stored in a suitable location, preferably engaged at another nearby suitable location within arm's reach, such as a nearby strut, post, or ledge of sufficient size for the piston fastener 22 or the lift support body fastener 24 to engage.

The above description is given by way of example, and not limitation. Given the above disclosure, one skilled in the art could devise variations that are within the scope and spirit of the invention disclosed herein, including various ways of configuring the various parameters of a bracing device. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A bracing device for use with a lift support body and a piston rod connected to the lift support body, the piston rod having a coupling device attached thereto, the piston rod being transitional relative to the lift support body between an extended position and a retracted position, the coupling device moving away from the lift support body as the piston rod transitions from the retracted position toward the extended position, the bracing device comprising:
a piston rod fastener configured to be selectively attachable to an outer surface of the piston rod so as to extend between the lift support body and the coupling device when attached to the piston rod; and
a lift support body fastener coupled to the piston rod fastener and configured to be selectively attachable to an outer surface of the lift support body, the piston rod fastener being disconnected from the piston rod when the lift support body fastener is attached to the outer surface of the lift support body.

2. The bracing device of claim 1, wherein the piston rod fastener is integrally formed with the lift support body fastener.

3. The bracing device of claim 1, wherein the piston rod fastener includes a pair of jaws being flexible relative to each other between an expanded position and a compressed position, wherein the pair of jaws move away from each other as they transition from the compressed position toward the expanded position.

4. The bracing device of claim 3, wherein each of the pair of jaws includes a prescribed profile including an arcuate segment.

5. The bracing device of claim 4, wherein each of the pair of jaws includes a pair of discrete arcuate segments.

6. The bracing device of claim 1, wherein the lift support body fastener includes a pair of jaws being flexible relative to each other between an expanded position and a compressed position, wherein the pair of jaws move away from each other as they transition from the compressed position toward the expanded position.

7. The bracing device of claim 6, wherein each of the pair of jaws includes a prescribed profile including an arcuate segment.

8. The bracing device of claim 7, wherein each of the pair of jaws includes a pair of discrete arcuate segments.

9. The bracing device of claim 1, wherein the piston rod fastener includes a uniform cross section along a length of the piston rod fastener between opposed end faces thereof.

10. The bracing device of claim 1, wherein the lift support body fastener includes a uniform cross section along a length of the lift support body fastener between opposed end faces thereof.

11. The bracing device of claim 1, further comprising a joint region disposed between the piston rod fastener and the lift support body fastener, the piston rod fastener extending from the joint region in a direction opposite the lift support body fastener.

12. A bracing device for use with a lift support body and a piston rod connected to the lift support body, the piston rod having a coupling device attached thereto, the piston rod being transitional relative to the lift support body between an extended position and a retracted position, the coupling device moving away from the lift support body as the piston rod transitions from the retracted position toward the extended position, the bracing device comprising:
a first fastener having a pair of opposing first fastener bodies separated from each other and configured to be selectively attachable to the piston rod, with the piston rod being captured between the pair of opposing first fastener bodies, so as to extend between the lift support body and the coupling device when attached to the piston rod; and
a second fastener coupled to the first fastener and having a pair of second fastener bodies separated from each other and configured to be selectively attachable to the lift support body, with the lift support body being captured between the pair of opposing second fastener bodies, the first fastener being disconnected from the piston rod when the second fastener is attached to the outer surface of the lift support body.

13. The bracing device of claim 12, wherein the first fastener is integrally formed with the second fastener.

14. The bracing device of claim 12, wherein the pair of first fastener bodies are configured to be flexible relative to each other between an expanded position and a compressed position, wherein the pair of first fastener bodies move away from each other as they transition from the compressed position toward the expanded position.

15. The bracing device of claim 14, wherein each of the pair of first fastener bodies includes a prescribed profile including an arcuate segment.

16. The bracing device of claim 15, wherein each of the pair of first fastener bodies includes a pair of discrete arcuate segments.

17. The bracing device of claim 12, wherein the pair of second fastener bodies are configured to be flexible relative to each other between an expanded position and a compressed position, wherein the pair of second fastener bodies move away from each other as they transition from the compressed position toward the expanded position.

18. The bracing device of claim 17, wherein each of the pair of second fastener bodies includes a prescribed profile including an arcuate segment.

19. The bracing device of claim 18, wherein each of the pair of second fastener bodies includes a pair of discrete arcuate segments.

20. The bracing device of claim 12, further comprising a joint region disposed between the first fastener and the second fastener, the first fastener extending from the joint region in a direction opposite the second fastener.
